(19) United States
(12) Patent Application Publication
(10) Pub. No.: US 2011/0184792 A1
(43) Pub. Date: Jul. 28, 2011

(54) SOCIAL NETWORK REWARDS

(75) Inventors: Thomas C. Butcher, Seattle, WA (US); Jessica E. Zahn, Renton, WA (US)

(73) Assignee: MICROSOFT CORPORATION, Redmond, WA (US)

(21) Appl. No.: 12/695,747

(22) Filed: Jan. 28, 2010

(51) Int. Cl. G06Q 30/00; G06Q 99/00; G06Q 50/00

(52) U.S. Cl. 705/14.13; 705/14.2; 705/14.25; 705/14.39; 705/319

(57) ABSTRACT

Social network reward techniques are described. In an implementation, a method implemented by at least one computing device includes obtaining data that describes users' interaction with a social network service and determining influence of one or more said users on other said users via the social network service from the obtained data. A reward is computed based on the determined influence for at least one said user.

Social network services continue to increase in popularity. For example, users may leverage a social network service to find and interact with other users, such as friends, business contacts, and so on. This interaction may be performed in a variety of ways, such as through messaging, photo sharing, posting videos, and so on. Additionally, this interaction may take a variety of different forms.

For example, users may interact regarding a variety of different topics such as from talking about their families to their respective experience with products or services. In some instances, a user may even develop a significant following of other users (e.g., a large collection of friends) that are interested in these topics as discussed by the user. However, the user's interaction via the social network service traditionally lessened over time, e.g., the user may develop other interests that resulted in less time being spent interacting via the social network service. Consequently, the other users that were interested in one or more of the topics may have a diminished experience with respect to the social network service, which could adversely affect the social network service itself.

### SUMMARY

Social network reward techniques are described. In an implementation, a method implemented by at least one computing device includes obtaining data that describes users' interaction with a social network service and determining influence of one or more said users on other said users via the social network service from the obtained data. A reward is computed based on the determined influence for at least one said user.

In an implementation, a method is implemented by at least one computing device, the method includes computing an effect of a reward, associated with a product or service, on communications via a social network service between users of the social network service. A communication is formed to communicate the computation for display in a user interface to show the effect of the reward.

In an implementation, one or more tangible computer-readable media comprising instructions stored thereon that, responsive to execution on a computing device, causes the computing device to determine influence of users of a social network service on each other, ascertain which of the users are to receive one of a predetermined number of rewards based on the determined influence, and communicate a notification of the rewards to the ascertained users via corresponding user accounts of the social network service.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform social network service reward techniques.

FIG. 2 is an illustration of an example system that depicts computation of rewards in an example implementation.

FIG. 3 is an illustration showing an example implementation in which a user interface is output by a client device of FIG. 1 to interact with a social network service.

FIG. 4 is a flow diagram that depicts a procedure in an example implementation in which a reward is computed based on influence in a social network service.

FIG. 5 is a flow diagram that depicts a procedure in an example implementation in which a monetary amount is assigned for providing a reward in conjunction with a social network service.

### DETAILED DESCRIPTION

Overview

Influential users in a social network services may be valuable both to the service itself as well as and to other users of the service. For example, influential users may recommend media to their friends (and likewise to friends of these friends) explicitly by sharing messages about the media with their friends, implicitly through recounting experiences with the media, and so on. Thus, the importance of these influential users may also extend to providers of the media that is being discussed by the influential users. However, the influential users may develop new interests and therefore spend less time interacting with the social network service. This may be detrimental to the social network service itself, users of the social network service, and the providers of the goods and services discussed by the influential user.

Social network rewards are described. In an implementation, rewards are provided which may be used to encourage users to interact via the social network service. Additionally, the rewards may be used to encourage users to interact via the social network service regarding particular goods and/or services. Further, the rewards may be used to encourage users to increase their influence on other users of the social network service since this also can drive engagement and monetization of the network, e.g., to providers of goods and services.

In the following discussion, an example environment is first described that is operable to perform social network reward techniques. Example procedures are then described which may be employed by the example environment. However, it should be readily apparent that the example environment is not limited to performing the example techniques and the example techniques are not limited to performance in the example environment.

Example Environment

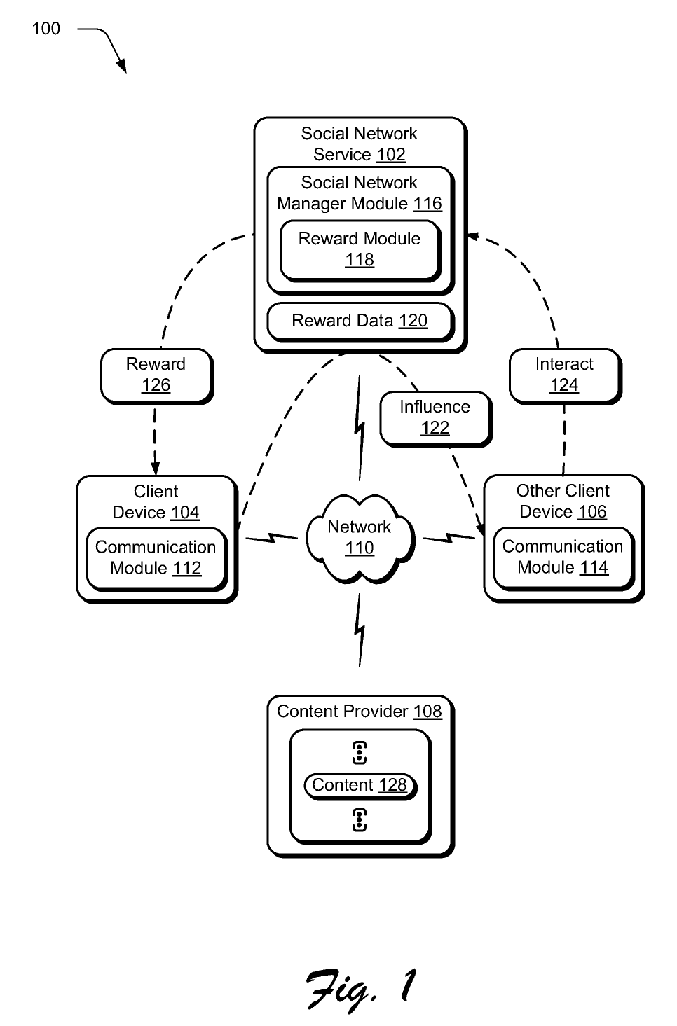

FIG. 1 is an illustration of an environment 100 in an example implementation that is operable to employ social network reward techniques. The illustrated environment 100 includes a social network service 102, a client device 104, another client device 106, and a content provider 108, each of which are communicatively coupled, one to another, over a network 110.

The client devices 104, 106 may be configured in a variety of ways. For example, the client devices 104, 106 may be configured as a computer that is capable of communicating over the network 110, such as a desktop computer, a mobile station, an entertainment appliance, a set-top box communicatively coupled to a display device, a wireless phone, a game console, and so forth. Thus, the client devices 104, 106 may range from full resource devices with substantial memory and processor resources (e.g., personal computers, game consoles) to a low-resource device with limited memory and/or processing resources (e.g., traditional set-top boxes, hand-held game consoles). The client devices 104, 106 may also relate to an entity that operates the client devices 104, 106. In other words, client devices 104, 106 may describe logical clients that include software in the following discussion.

Although the network 110 is illustrated as the Internet, the network may assume a wide variety of configurations. For example, the network 110 may include a wide area network (WAN), a local area network (LAN), a wireless network, a public telephone network, an intranet, and so on. Further, although a single network 110 is shown, the network 110 may be configured to include multiple networks. For instance, the social network service 102 and the client devices 104, 106 may be communicatively coupled via the Internet. Additionally, both the client devices 104, 106 may be communicatively coupled via a local wireless network. A wide variety of other instances are also contemplated.

The client devices 104, 106 are each illustrated as including a respective communication module 112, 114. The communication modules 112, 114 are representative of functionality of the respective client devices 104, 106 to communicate via the network 110. For example, the communication modules 112, 114 may include browser functionality to interact with the social network service 102 via the network 110.

The social network service 102 may support a variety of different functionality which is represented by the social network manager module 116. Through the social network manager module 116, for instance, the social network service 102 may support communication of status updates between the client devices 104, 106 that have been specified as friends of each other. Additionally, the specified “friendship” of the social network service 102 may be used as a basis to permit sharing of photos, video, blogs, and so on. Thus, the social network service 102 may use the friend relationship as a permissioning technique to permit or restrict access to content associated with a user's account of the social network service 102.

For instance, the client device 102 may be associated with a user's account of the social network service 102. Through this user account, the client device 104 may be used to specify a friend, such as a user account of the social network service 102 that is accessible via the other client device 106. By doing this, the other client device 106 is permitted to access content associated with the client device 104, such as content associated with an account of the social network service 102 of a user of the client device 104 that provided credentials to access the user account. Although a permissioning technique regarding friends have been described, it should be readily apparent that the social network service 102 may be configured in a variety of ways to support communication between users, such as by communicating status updates to subscribers of a particular user's network feed.

The social network service 102, and more particularly the social network manager module 116, is also illustrated as including a reward module 118 that is representative of functionality regarding rewards. In an implementation, the reward module 118 may be representative of functionality of the social network service 102 to determine an influence of users of the social network service 102 on each other through examination of reward data 120.

In the illustrated example, the reward data 120 describes influence 122 of a user of the client device 104 on a user of the other client device 106, e.g., via interaction with the social network service 102. This influence 122 is also described by the reward data 120 as causing subsequent interaction 124 by the user of the other client device 106 with the social network service 102. Accordingly, the reward module 118 in this example determines that a user of the client device 104 is to receive a reward 126 for this influence 122 of the user of the other client device 106. Thus, in this example the reward 126 is given in response to the influence 122 has occurred, e.g., is “after the fact.” A variety of other implementations are also contemplated, such as to give the reward 126 to encourage subsequent influence 122.

For example, a reward 126 may be issued by the reward module 118 via the social network service 102, such as to obtain content 128 (e.g., a ringtone) pertaining to a new movie from the content provider 108. A user of the client device 104 may then influence 122 the user of the other client device 106 regarding this reward 126, such as to communicate that the reward 126 is available to other users also via the social network service 102. The user of the other client device 106 may then interact 124 with the social network service 102 or other entity (e.g., a third party provider) to obtain the reward 126. Thus, in this example the reward 126 is configured to increase publicity for the movie by disseminating the reward in the hope that the reward will subsequently influence behavior, e.g., talk about the movie because of the ringtone.

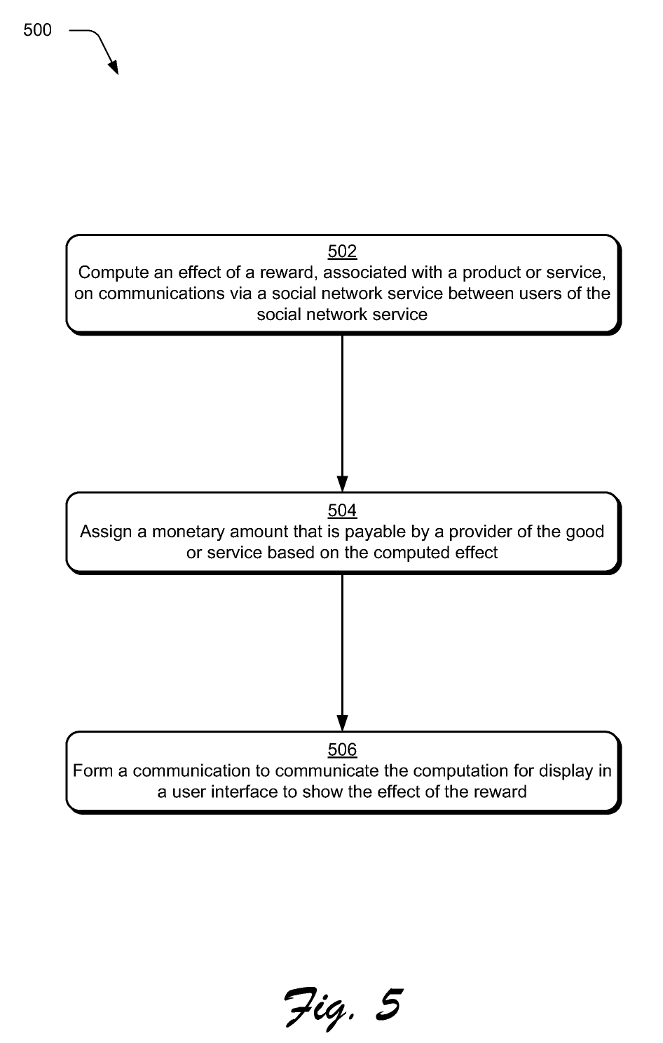

In either case, the reward module 118 may be configured to monitor and calculate the influence 122 that results from the reward 126. This calculated influence may then be used to monetize provision of the reward 126 in relation to the social network service 102. For example, the social network service 102 may provide a service to the content provider 108 the shows the effect of the reward 126 on users of the social network service 102 and/or the influence of users on each other via social network service 102 regarding the reward 126. Accordingly, the social network service 102 may monetize (e.g., charge a fee) for providing the reward 126 in association with the service, further discussion of which may be found in relation to FIG. 5.

The reward 126 may pertain to a variety of goods or services. For example, the rewards may refer to content 128 that is available via the network 110 from the content provider 108. The reward 126 may also refer to content that is not available via the network 110, such as a live performance, content available from a traditional “bricks and mortar” store (e.g., a printed book), and so on. Additionally, the reward 126 may be communicated to the client devices 104, 106 in a variety of ways, such as via the network 110 or other communication technique (e.g., text message, phone message, and so on). Further discussion of computation of the reward 126 and the reward 126 itself may be found in relation to the following figure.

Generally, any of the functions described herein can be implemented using software, firmware, hardware (e.g., fixed logic circuitry), manual processing, or a combination of these implementations. The terms “module” and “functionality” as used herein generally represent software, firmware, hardware, or a combination thereof. In the case of a software implementation, the module or functionality represents program code that performs specified tasks when executed on a processor (e.g., CPU or CPUs). The program code can be stored in one or more computer readable memory devices, e.g., memory or other tangible media. The features of the reward techniques described below are platform-independent, meaning that the techniques may be implemented on a variety of commercial computing platforms having a variety of processors.

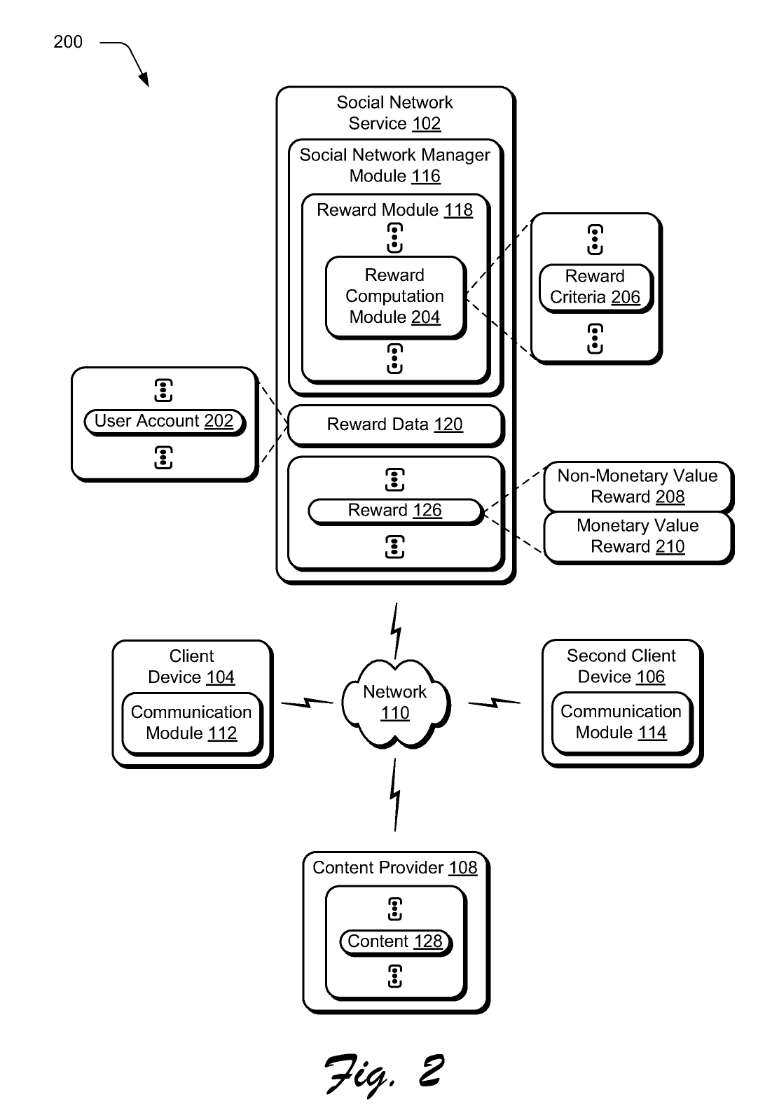

FIG. 2 depicts an example system 200 illustrating computation of rewards in an example implementation. In the illustrated implementation, the reward data 120 is identified according to one or more user accounts 202 of the social network service 102. In this way, the reward module 118 may identify which users are described by the reward data 120.

The reward data 120 may describe a variety of interaction, both with the social network service 102 and other services. For example, the reward data 120 may describe communications that were performed in association with the social network service 102, such as emails, status messages (e.g., to specify friends and/or published to subscribers), content shared by the users (e.g., songs, video clips, and other media), links (and the content referenced by the links) that are shared/posted by the user, blogs, comments made regarding other users communications, and so on. The reward data 120 may also describe network 110 navigation performed by an associated user, such as which webpages of the social network service 102 and/or other websites were visited by the users. Thus, the reward data 120 may describe a variety of different interactions that may be performed over the network 110 as well as other types of interaction, e.g., a purchase made at a bricks-and-mortar store using a coupon provided by the reward module 118.

The reward module 118 is further illustrated in FIG. 2 as including one or more reward computation modules 204. The reward computation modules 204 are representative of functionality of the social network service 102 to examine the reward data 120 to determine which of the users that correspond to the user accounts 202, if any, qualify for a reward 126. For example, each of the reward computation modules 204 may be associated with a variety of different reward criteria 206 that are usable to determine which of the user accounts 202 (and consequently users associated with the accounts) qualify for one or more of the rewards 126. Examples of reward criteria 206 include a number of mentions of particular keywords, postings of links, content, and so on. Additionally, the reward criteria 206 may be used to provide a limited number of rewards, assign the rewards 126 accordingly to a reward hierarchy, and so on.

Although some examples of reward criteria 206 have been listed, it should be apparent that a variety of other criteria are also contemplated, such as how many instances of the reward 126 are available for distribution, how often the rewards 126 may be granted, a lifespan after which the reward 126 expires, and so on. Thus, the rewards 126 may be managed in a variety of different ways by the reward computation modules 204 of the reward module 118.

Further, the reward computation module 204 may apply the reward criteria 206 to subsets of the population of users that interact with the social network service 102. This allows the rewards 126 to be scoped to an individual user and users in that user's proximity. For example, subset rewards might have corresponding reward criteria 206 that define that a given rewards 126 may be issued “N” number of times within the subset having “X” number of users or less.

Additionally, a variety of different rewards 126 may be managed by the reward module 118. For example, the reward 126 may be configured as a non-monetary value reward 208, such by providing special recognition, code that is executable in relation to a user's profile (e.g., special icons, user badge, or backgrounds), downloadable content (e.g., free media such as songs, ringtones, video clips), and so on. The reward 126 may also be configured as a monetary value reward 210, such as points that may be redeemed for a good or service, providing downloadable content that otherwise would be provided for a fee (e.g., media such as songs, ringtones, video clips), goods or services themselves (e.g., T-shirts and other branded material), and so on.

Thus, this system 200 may define a set of rewards 126 that can be assigned to users of the social network service 102. These rewards 126 can have no “real-world” value (e.g., non-monetary value rewards 208), such as exclusive icons or placement of the user in a public leader board. Additionally, the rewards 126 can have an actual value (e.g., monetary value rewards 210), such as points for downloading music or videos for free. One other example is a “sweepstakes” style reward that provides an opportunity to win an even larger reward, e.g., an opportunity (a first reward) to win a free trip to a concert featuring a particular band (a second reward). It should be readily apparent that these reward types may be mixed in a hierarchy to provide rewards 126 having an increasing value based on increased influence of the user on other users, e.g., from non-monetary to monetary rewards having increasing value in the hierarchy.

In an implementation, computation of the rewards 126 is performed by following a resource allocation algorithm that uses a mathematical function to allocate the rewards to the highest ranked nodes in a social graph. The resource allocation algorithm in this example may distribute the rewards according to an influence distribution as well as enforce additional business rules and considerations, e.g., geographical considerations.

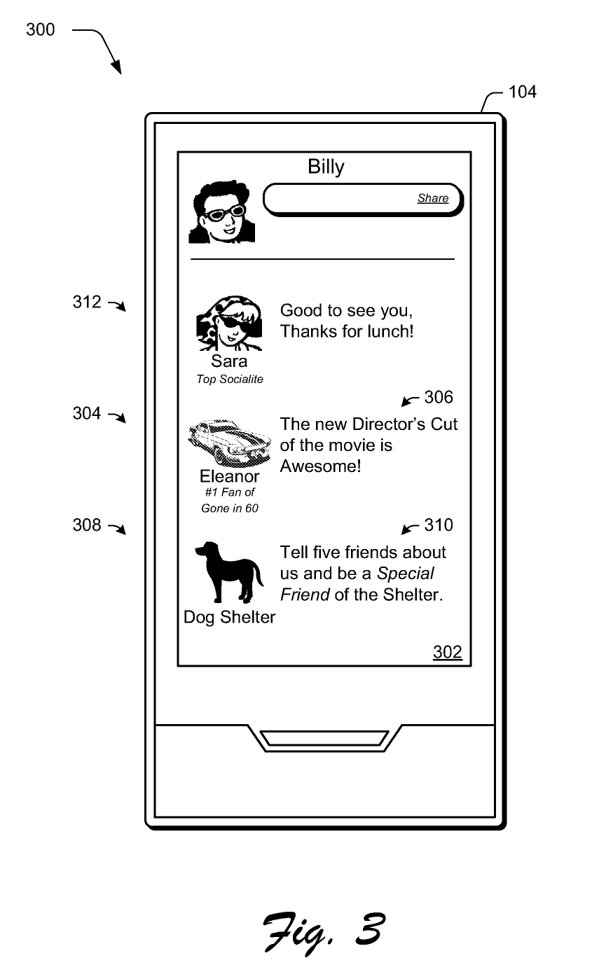

The reward module 118 may also be configured to notify intended recipients of the rewards 126 in a variety of ways. For example, the reward module 118 may issue a message to the user, may feature the user in a broadcast message, and so on. Use of the broadcast message may encourage other users to become influential as well as to give the influential user clout among his peers. An example of rewards associated with user profiles and otherwise may be found in relation to FIG. 3.

FIG. 3 is an illustration showing an example implementation 300 in which a user interface 302 is output by the client device 104 of FIG. 1 to interact with the social network service 102. This user interface 302 is configured to display a network feed of status updates for friends of a user “Billy” in the social network service 102.

Different examples of influence are shown in the status updates from the friends. For example, a friend “Eleanor” 304 includes a status update 306 that states “The new Director's Cut of the movie is Awesome!” which is an example of implicit influence that describes the user's experience with a good or service, e.g., the movie. An example of explicit influence is also shown for the friend “Dog Shelter” 308 communicated a status update 310 that states “Tell five friends about us and be a Special Friend of the Shelter.” A variety of other examples are also contemplated.

The user interface 302 also includes examples of rewards that are included as a part of a user's profile. For example, Eleanor 304 includes a reward that states that Eleanor is the “#1 Fan of Gone in 60” while Sara 312 has received the “Top Socialite” reward. A variety of other examples of rewards are also contemplated, include the rewards 126 previously and subsequently described.

Example Procedures

The following discussion describes reward techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1, the system 200 of FIG. 2, and the client device 104 of FIG. 3.

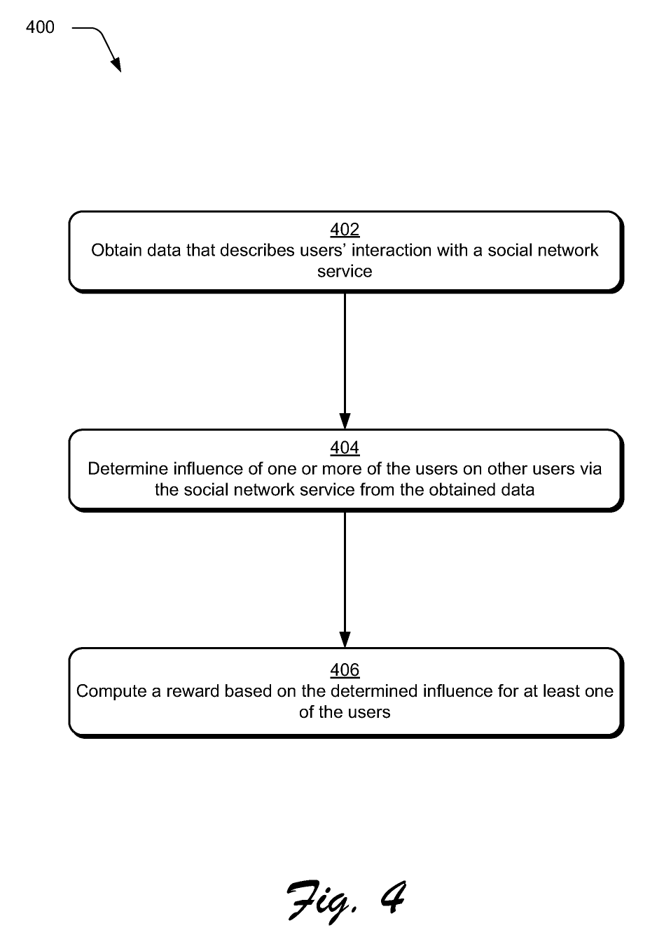

FIG. 4 depicts a procedure 400 in an example implementation in which a reward is computed based on influence in a social network service. Data is obtained that describes users' interaction via a social network service (block 402). For example, the reward module 118 may be configured to monitor communications, link sharing, media sharing, and so on that is performed in conjunction with the social network service 102. In another example, the data is the substance of communications sent via the social network service 102.

Influence of one or more of the users on other users via the social network service is determined from the obtained data (block 404). For example, the influence may be based on the amount of users that received a communication, either directly or through another user.

A reward is computed based on the determined influence of at least one of the users (block 406). For example, a resource allocation algorithm may also be used that employs a mathematical function to allocate the rewards to the highest ranked nodes in a social graph. The resource allocation algorithm in this example may distribute the rewards according to an influence distribution as well as enforce additional business rules and considerations, e.g., geographical considerations. In an implementation, the computation of the reward may be made with the determination of the influence, such as through use of the social graph above.

In an implementation, the reward computation may include multiple influence computation formulas. For example, a music influencer reward may promote music-related events like song sharing and downloads during computation of influence but demote video review events. Conversely, a “top socialite” reward may promote social graph events like friend add, messaging, and so forth higher than media consumption events. A variety of other examples are also contemplated.

FIG. 5 depicts a procedure 500 in an example implementation in which a monetary amount is assigned for providing a reward in conjunction with a social network service. An effect of a reward, associated with a product or service, on communications performed via a social network service between users of the social network service is computed (block 502). For example, the reward module 118 may determine how many times the reward 126 was mentioned in communications performed via the social network service, a number of postings of links to the reward 126, a number of times the reward 126 was accessed, and so on.

A monetary amount is assigned that is payable by a provider of the good or service based on the computed effect (block 504). The reward module 118, for instance, may assign a monetary amount based on magnitude of the effect, such as the number of mentions, communications that contain the mentions, and so on from the factors previously described.

A communication is formed to communicate the computation for display in a user interface to show the effect of the reward (block 506). The communication may be configured in a variety of ways, such as for communication via the social network service 102 (e.g., a message, posting to a user's profile, and so on) or via other services, such as text messaging, email over the network 110, and so on. Additionally, the communication may be formed as part of a web page that is accessible via a browser, e.g., by the communication module 112 of the client device 104 using browser functionality.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by at least one computing device, the method comprising:
obtaining data that describes users' interaction via a social network service;
determining influence of one or more said users on other said users via the social network service from the obtained data; and
computing a reward based on the determined influence for at least one said user.

2. A method of claim 1, wherein the data describes status updates communicated via the social network service.

3. A method of claim 1, wherein the data describes content sharing that was performed via the social network service.

4. A method of claim 1, wherein the data describes one or more references to a live event communicated via the social network service.

5. A method of claim 1, wherein the reward is a nonmonetary reward.

6. A method of claim 5, wherein the nonmonetary reward includes an indicator that is viewable via the at least one user's profile in the social network service.

7. A method of claim 1, wherein notifications of the rewards are communicated via an email or a SMS text.

8. A method of claim 1, wherein the computing of the influence is based at least in part on a number of communications involving the reward that were communicated via the social network service that were initiated by each said user, respectively, that caused subsequent communications via the social network service.

9. A method of claim 1, wherein the computing of the influence includes computing an influence graph.

10. A method of claim 1, wherein the reward is one of a plurality of said rewards that are arranged in a hierarchy according to one or more criteria that are used to perform the determination.

11. A method implemented by at least one computing device, the method comprising:
computing an effect of a reward, associated with a product or service, on communications via a social network service between users of the social network service; and
forming a communication to communicate the computation for display in a user interface to show the effect of the reward.

12. A method of claim 11, wherein the communicating also includes an indicated monetary amount that is chargeable to a provider of the product or service regarding the reward.

13. A method of claim 12, wherein the monetary amount is based at least in part on the computed effect.

14. A method of claim 11, wherein the reward is associated with user profiles of the social network service.

15. A method of claim 11, wherein the reward is a nonmonetary reward that is configured to recognize one or more of the users of the social network service that initiated communications regarding the product or service.

16. A method of claim 11, wherein the service is a live event.

17. A method of claim 11, wherein the computing of the influence is based at least in part on a number of communications involving the reward that were communicated via the social network service that were initiated by each said user, respectively, that caused subsequent communications via the social network service.

18. One or more tangible computer-readable media comprising instructions stored thereon that, responsive to execution on a computing device, causes the computing device to:
determine influence of users of a social network service on each other;
ascertain which of the users are to receive one of a predetermined number of rewards based on the determined influence; and
communicate a notification of the rewards to the ascertained users via corresponding user accounts of the social network service.

19. One or more tangible computer-readable media of claim 18, wherein the determination of the influence is based at least in part on a number of communications involving the reward that were communicated via the social network service that were initiated by each said user, respectively, that caused subsequent communications via the social network service.

20. One or more tangible computer-readable media of claim 18, wherein the rewards are arranged in a hierarchy according to one or more criteria.
